(19) United States
(12) Patent Application Publication
(10) Pub. No.: US 2007/0156706 A1
(43) Pub. Date: Jul. 5, 2007

(54) APPARATUS, SYSTEM, AND METHOD FOR MONITORING THE USAGE OF COMPUTERS AND GROUPS OF COMPUTERS

(76) Inventor: Christian Hayes, Farmington, UT (US)

Correspondence Address: Kunzler & McKenzie, 8 EAST BROADWAY, SUITE 600, SALT LAKE CITY, UT, 84111, US

(21) Appl. No.: 11/616,777

(22) Filed: Dec. 27, 2006

Related U.S. Application Data
(60) Provisional application No. 60/754,077, filed on Dec. 27, 2005.

(51) Int. Cl. G06F 17/30

(52) U.S. Cl. 707/10

(57) ABSTRACT

An apparatus, system, and method for monitoring the usage of computers and groups of computers. A small program called the client module is installed on a client, and a corresponding server module program is installed on a server. The client agent monitors the client for a change in status at regular intervals and sends client usage data to the server if there is a change in status. The client agent also sends client usage data to the server at a regular update interval regardless of whether a status change on the client occurs. A user can group clients into labs and generate reports detailing lab usage, client usage, and user activity. The program also alerts a system administrator of possible problems with individual computers and labs. The program additionally provides a dynamic map which displays real-time status information on labs and computers.

### CROSS-REFERENCES TO RELATED APPLICATIONS

This application claims the benefit of United States Provisional Patent Application No. 60/754,077 entitled “APPARATUS, SYSTEM, AND METHOD FOR MONITORING THE USAGE OF COMPUTERS AND GROUPS OF COMPUTERS” and filed on Dec. 27, 2005 for Christian Hayes, which is incorporated herein by reference.

### BACKGROUND OF THE INVENTION

1. Field of the Invention

This invention relates to monitoring the usage of individual computers and groups of computers and, more specifically to tracking computer usage in a computer lab environment,

2. Description of the Related Art

The computer is becoming a necessity in modern life. Most teachers require that essays and papers be typed. Many classes now require that students submit homework via the internet. Business documents and files often need to be electronic to facilitate easy transfer and review. And the internet has become a critical resource for a variety of activities, from job searching to financial aid.

Not all individuals, however, are able to access a computer from home. As a result, the need for public access to computers has grown immensely over the past twenty years. Schools and libraries have seen an increase in the need for computing capability on their premises. For example, most universities and colleges have clusters of networked computers in computer labs available for students and faculty to use. These labs provide the academic community with critical access to a wealth of resources such as word processing, internet access, and technical computing programs.

Creating, staffing, and maintaining these labs, however, is often a costly endeavor. Labs require staff, computers, program licenses for applications, and a host of other expensive peripherals. Labs also require maintenance, a requirement exasperated when some select users purposely introduce malware or otherwise harm and damage a lab computer. Budgets for information technology are tight for schools, libraries, and businesses across the country. With budgets shrinking as demand grows, it is imperative that lab managers know how the labs are being used and when; knowing which labs have the greatest use allows administrators to properly allocate funds for computing and ensure that labs are running and meeting the requirements placed on them by users.

There is a need for a tool capable of monitoring individual computer, lab, and user usage information. This tool must use a minimum of system resources and be able to easily provide a picture of usage patterns as well as individual user history. In addition, it must be capable of providing information concerning the operational status of individual computers in labs and allow an administrator and her staff to quickly communicate when, where, and what problems exist for a particular computer.

### BRIEF SUMMARY OF THE INVENTION

The present invention has been developed in response to the present state of the art, and in particular, in response to the problems and needs in the art that have not yet been fully solved by currently available apparatus and methods. Accordingly, the present invention has been developed to provide a method, apparatus, and system for monitoring the usage of computers and groups of computers in a lab environment.

The present invention is a method for monitoring the usage of one or more clients or groups of clients, the method comprising creating lab definitions and assigning clients to a lab instance, monitoring a client for a change in status at regular intervals and sending client usage data to a server if there is a change in status, and sending client usage data to the server at a regular update interval regardless of whether a status change on a client occurs. The method further comprises auto-populating a database with the client usage data, organizing it in a database such that each client has a unique client record in a database, and querying the status of each client record at regular intervals and storing the result in a separate record in a database. The data stored in the database is then used to generate lab usage reports, client usage reports, user usage reports, and a dynamic map report which automatically updates the reported status of each client on the map based on the client usage hdata continually being recorded in the database.

An apparatus to monitor the usage of one or more clients or groups of clients is also provided. The apparatus comprises a lab creation module configured to create lab definitions and assign clients to a lab instance according to a lab definition; a lab management module is configured to allow a user to modify a lab definition and add and remove clients from a lab instance. A client agent module is configured to monitor, at regular intervals, a client for changes in status and send client usage data to the server if there is a change in status, and to transmit client usage data to the server at regular user-defined intervals. The apparatus further comprises a population module configured to receive messages from client agent modules and auto-populate a database with the client usage data provided such that each client has a unique client record in a database. A monitor module is configured to query the status of each client record at regular intervals and store the result in a separate record in a database.

The apparatus further comprises a client management module configured to modify data gathering settings on a client agent, to log a user off of a client and change a client's status to offline if a client fails to send an update for a specified number of update intervals, and to send a notification to a specified user if a client is offline for a given time interval or if the client is online but has not been logged into for a given time interval.

The apparatus further comprises a report module configured to generate reports of client, user, and lab events. The report module also sends a notification to a defined user in response to the occurrence of a predefined event. A mapping module is configured to create graphical maps of clients assigned to a lab instance, provide client status and lab information for a given client or lab, and update client status and lab information in response to changes in status. In addition, the mapping module allows a user to add or remove a descriptive ticket assigned to a client for display on a graphical map.

A system for monitoring the usage of one or more clients or groups of clients is also provided, the system comprising one or more clients and one or more labs composed of said clients. A server is in electronic communication with the clients and a database is in electronic communication with the server. The system also comprises client agent modules installed on clients and configured to monitor a client for a change in status at regular intervals and send client usage data to the server if there is a change in status, and to autonomically transmit client usage data to the server at regular intervals. The system also comprises a server agent module installed on a server and configured to receive messages from a client agent module and to query the status of each client record at regular intervals and store the result in a separate record in the database. The server agent module further comprises the lab creation module, population module, monitor module, lab management module, client management module, report module, and mapping module as described above.

The present invention provides a novel method, apparatus, and system for monitoring the usage of one or more client or groups of clients. The features and advantages of the present invention will be more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system to monitor the usage of one or more clients in accordance with the present invention;

FIG. 2 is a schematic block diagram illustrating one embodiment of a server agent in accordance with the present invention;

FIG. 3 is a schematic block diagram illustrating one embodiment of a database in accordance with the present invention;

FIG. 4 is a schematic flow chart diagram illustrating one embodiment of method for monitoring the usage of one or more clients in accordance with the present invention; and

FIG. 5 is a schematic block diagram illustrating one embodiment of client usage reports generated in accordance with the present invention.

FIG. 6 is a schematic block diagram illustrating one embodiment of user usage reports generated in accordance with the present invention.

FIG. 7 is a schematic block diagram illustrating one embodiment of a lab map graphical interface in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention. The term “lab” in this specification may refer to the physical existence of a group of computers or computer equipment available for access by various users, and in other instances, “lab” may refer to the representation of existing or non-existing physical labs by computer code or software architecture.

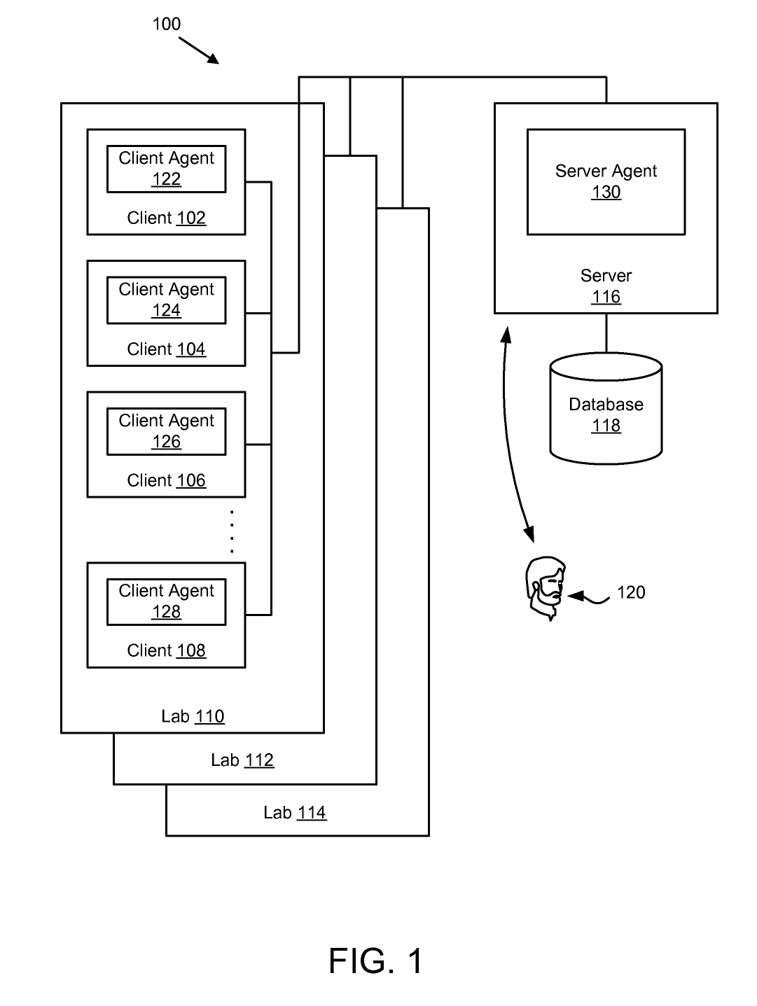

FIG. 1 is a schematic block diagram illustrating one embodiment of a system 100 for monitoring the usage of one or more clients 102-108 in accordance with the present invention. The system 100 includes one or more clients 102-108 housed within one or more labs 110-114 that are in electronic communication with a server 116. The server 116 is in electronic communication with a database 118 and is configurable by a user 120. Each of the clients 102-108 includes a client agent 122-128, and the server 116 includes a server agent 130. Those of skill in the art recognize that the system 100 may be more simple or complex than illustrated so long as the system 100 includes modules or sub-systems that correspond to those described herein.

Typically, the clients 102-108 are computers comprising a processor and memory for executing software and/or firmware to control and manage the other components within the clients 102-108. The clients 102-108 preferably include an operating system such as Windows, Linux, Unix, Macintosh, or other operating system as will be recognized by one skilled in the art. A client agent 122-128 is installed onto each of the clients 102-108 such that the client agent 122-128 retrieves usage data corresponding to the client's 102-108 status and sends the data to the server 116. The client agent 122-128 monitors the client 102-108 for status changes at regular configurable intervals, such as every five seconds, and sends updates to the server 116 in response to the detection of a status change. In addition to sending an update when a change in status is detected, the client agent 122-128 sends status updates to the server 116 at regular configurable intervals, such as every one to two minutes, even if a status change has not been detected. In one embodiment, these intervals may be set to the same value so that the server 116 receives a regular communication update from the client 102-108 irrespective of any status changes.

For example, if the client 102-108 were located in a computer lab in a university setting such that students could enter the lab and login to the client 102-108, then a client 102-108 may have three possible states: “in use”, “available”, and “offline.” The client agent 122-128 detects when a student logs in and subsequently sends data to the server 116 indicating that the client's 102-108 status changed from “available” to “in use.” Then, when the student logs out, the client agent 122-128 sends another update indicating the client's 102-108 status has changed back to “available.” If the student has been logged in for more than ten minutes without a change in status, the client agent 122-128 sends an update to the server 116 indicating that the status has not changed. In one embodiment, the data is sent as XML data to the server 116 by the client agent 122-128 and includes client usage data such as the login status, IP address, MAC address, client ID, or hostname of the client 102-108. User information such as student username or identification number may also be sent and may include other information such as which programs were used and which websites were visited.

In one embodiment, the client agent 122-128 may be installed manually onto each of the clients 102-108 from removable media such as a disk or other device, and in another embodiment, the software may be installed onto each client 102-108 over a network in a mass installation.

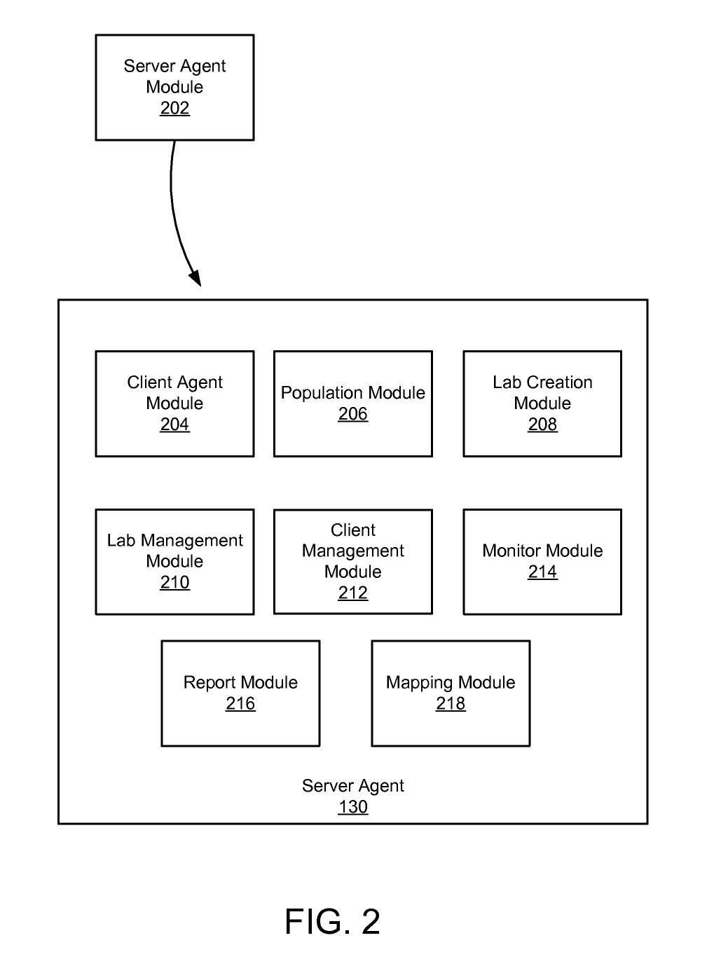

The server 116 is typically a web server such as Apache Tomcat, or other web server recognized by one skilled in the art. The server agent 130 is installed onto the server 116 by a user 120. In one embodiment, the server agent 130 is a collection of Java programs that function as sub-processes of Apache Tomcat. The server agent 130 may include the necessary modules to sufficiently monitor the usage of the clients 102-108. In one embodiment, the server agent 130 includes the modules required to: install a client agent 122-128 onto one or more clients 102-108 such that the client agent 122-128 transmits data in the case of a status change in addition to automatically transmitting client usage data to the server 116 at regular user-defined intervals; receive messages from client agents and auto-populate a database 118 with client usage data such that each client has a unique record in the database; create a lab instance and assign clients 102-108 to that lab instance according to one or more lab definitions; modify a lab definition; modify data gathering settings for the client agents 122-128 and the server agent 130; query the status of each client record at regular intervals and store the result in a separate record in the database; generate reports describing the usage of each client, user, and lab; and use the gathered data to create graphical maps of clients assigned to a lab that provide client up-to-date information in a given lab. The server agent 130 processes are described in detail below (see FIG. 2).

The server agent 130 may assign each client 102-108 to a lab instance. A user 120 may manually assign each client 102-108 to a designated lab instance, or each client 102-108 may be assigned to a lab instance automatically according to lab definitions. For example, in a university setting where there are many computer labs 110-114 located across a campus, a lab instance may be created corresponding to each physically existing lab 110-114 on the campus. Then, a server administrator may create lab definitions for each lab instance such that the clients 102-108 located in the physically existing lab 110-114 are assigned to the corresponding lab instance. In one embodiment, the lab definitions may include a range of IP addresses, and in another embodiment, the lab definitions may include a list of MAC addresses or hostnames. A user 120, such as a student, may then monitor the status updates from the clients 102-108 assigned to a particular lab instance and may discover which labs 110-114 have currently available clients 102-108. Furthermore, the server agent 130 may log data and generate reports regarding the usage of each individual client 102-108 as well as each lab 110-114.

The database 118 stores the usage data corresponding to the clients 102-108 when the data is received by the server 116. The database 118 also stores data generated by the server agent 130, which queries the status of each client record at a regular interval and takes a ‘snapshot’ of the information. From the data usage histories for clients 102-108, labs 110-114, and users, reports including graphs and charts may be generated.

FIG. 2 is a schematic block diagram illustrating one embodiment of a server agent 130. The server agent 130 is installed from the server agent module 202 which is typically located on removable media such as a disk. The server agent module 202 includes software to provide readable on-screen instructions such that a user 120 can install the web server, the scripting language, the database software, and the server agent 130. In one embodiment, the server agent 130 is installed with its accompanying programs such that they automatically run, both after the installation is finished and upon machine start-up. The server agent 130 includes a client agent module 204, a population module 206, a lab creation module 208, a lab management module 210, a client management module 212, a monitor module 214, a report module 216, and a mapping module 218. Upon installation of the server agent 130, a user 120 may configure the server agent 130 according to the user's preference.

The client agent module 204 is configured to install a client agent 122-128 onto one or more clients 102-108. For example, in the event a user 120 prefers to perform a mass installation of the client agent 122-128, the client agent module 204 provides the necessary software to do so. In another embodiment, the client agent module 204 is stored onto a removable storage device and installed manually onto each client 102-108. After the client agent 122-128 is installed, the client agent 122-128 runs automatically each time a client 102-108 is rebooted. In one embodiment, the client agent 102-108 runs as a service on a client's 102-108 operating system so it starts before login.

The first time the client agent 122-128 checks in after a reboot, the update sent to the server 116 from the client 102-108 may include the client's version number, ID number, IP address, MAC address, operating system type, and the number of users logged into the client 102-108. The client agent 122-128 then polls the client 102-108 for changes in status at regular configurable intervals. In one embodiment, the client agent 102-108 polls the client 102-108 for changes at five second intervals. If the client agent 122-128 finds a change in status, an update is sent to the server agent 130 on the server 116. Additionally, the client agent 122-128 sends updates of its usage status to the server 116 in regular configurable intervals regardless of whether or not there has been a change in status detected. In one embodiment, each usage status update sent by the client 102-108 following the initial usage status update includes the client's version number, the client's ID number, the number of users logged into the client, and the client's check-in interval. The data may also include information about the logged in users such as usemame.

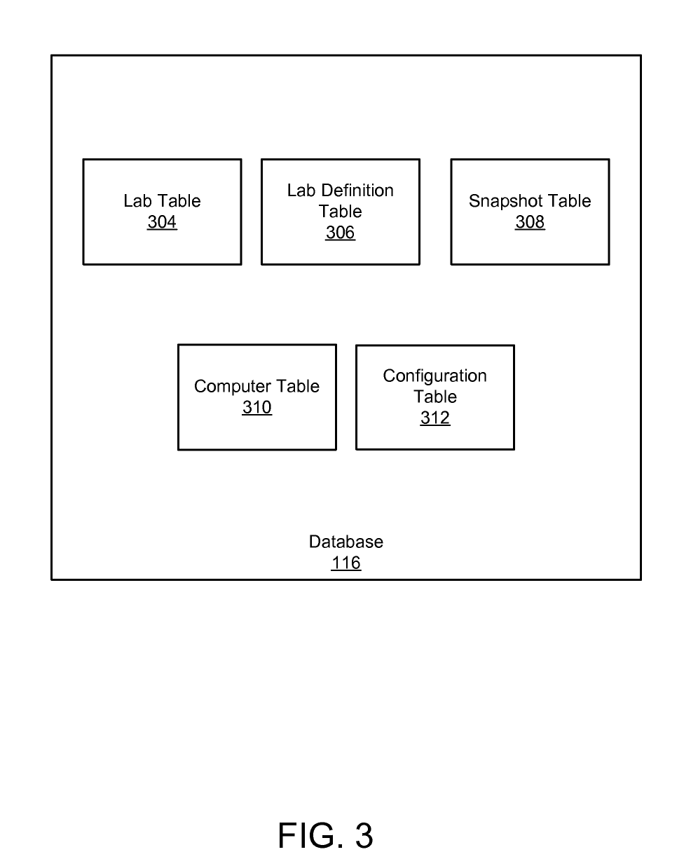

Updates sent by a client agent 122-128 are received by the population module 206, which creates a new record for it in the database 118. The population module 206 is configured to auto-populate the database 118 with the client usage data such that each client has a unique client record in the database 118. The database 118 is described in detail below (see FIG. 3).

The lab creation module 208 is configured to create a lab instance and assign clients 102-108 to that lab instance according to one or more lab definitions. Lab definitions define which clients 102-108 are assigned to which lab instances by using information such as IP addresses, hostnames, and MAC address. The lab definitions may define which clients 102-108 are to be included in the lab instance as well as which clients 102-108 are to be excluded from the lab instance. Once a lab instance is created by the lab creation module 208 and clients 102-108 are assigned to a lab instance, the population module 206 will immediately begin logging usage data for the lab instance and the included clients 102-108. Lab instances may be further modified by the lab management module 210.

The lab management module 210 is configured to modify lab definitions as well as add or remove clients 102-108 from a lab instance. In one embodiment, when a new client 102-108 registers with the server 116, the lab management module 210 checks to see if an existing lab definition includes the new client 102-108 and automatically assigns the client 102-108 to the lab instance if it finds a match. If not, the client 102-108 is left with an “unassigned” status until a lab instance is created that includes the client 102-108 in its lab definitions or the client 102-108 is manually assigned to a lab instance. The lab management module 210 may also retire a lab if it is disbanded, or discontinued. Retiring a lab instance stops the data gathering process for that lab but ensures that the usage history is kept in the database 118 for continued querying. In one embodiment, a retired lab instance can be revived or deleted. When a lab instance is deleted, all usage history for that lab instance is deleted from the database 118 and cannot be recovered.

In one embodiment, the lab management module 210 presents the user 120 with a user interface allowing the user 120 to manually create or alter lab definitions. In addition, the user 120 may use the lab management module 210 to manually assign individual clients 102-108 to a corresponding lab 110-114.

The monitor module 214 is configured to query the status of each client record stored on a database 118 at regular intervals and store the result in a separate record in the database 118. The monitor module 214 thus creates ‘snapshots’ of the client records which can be used to generate statistics and reports concerning client 102-108 and lab 110-114 usage over periods of time. In one embodiment, the monitor module 214 looks at the client records at ten minute intervals and each time determines whether a client 102-108 is in use, available, or offline. The monitor module 214 stores the number of clients 102-108 in each state in a separate record in the database 118. This information can then provide granular usage statistics for a wide variety of time periods without requiring extensive space in a database 118.

The client management module 212 is configured to change data gathering settings of the client agents 122-128 and the monitor module 214. In one embodiment, a client agent 122-128 may poll a client 102-108 for changes in status at five second intervals and may provide a regular status report regardless of change in status at one minute intervals. In one embodiment, the client management module 212 provides a user 120 with a graphical user interface allowing the user 120 to change both the polling and regular status report intervals to other than a provided default value. Similarly, the client management module 212 allows a user 120 to change the ‘snapshot interval’ of the monitor module 214.

The client management module 212 also tracks the number of regular status reports a client agent 122-128 misses. If a client agent 122-128 fails to provide a specified number of regular status reports to the population module 206 the client management module 212 logs the user off of the client 102-108 (if there is a user on the client) and changes the client 102-108 status to offline. For example if the number of check-in misses is set to three, and the client check-in interval is set to one minute, then after three minutes without a check in the client 102-108 is marked as “offline.” The client management module 212 also allows a user 120 to modify the number of check-in misses before a client 102-108 is deemed offline.

Each time the client agent 122-128 checks in, the client management module 212 may respond by sending the client 122-128 an acknowledgment of data received, a new client-ID number, a new check in interval, and/or an offset to add to the first check in time on the new interval. In response, the client agent 122-128 adjusts its transmission intervals and data collection behaviors accordingly.

The client management module 212 may also enable/disable whether or not the login by a remote user to a client 102-108 causes the server agent 130 to mark the client 102-108 as “in use.” Even if a remote user does cause the client to be marked as “in use”, the remote user's login and logout information may still be recorded. The client management module 212 may also automatically delete user information after a specified number of days and may exclude some users from having their data logged.

The client management module 212 may be further configured to notify a designated user of the occurrence of a specified event. For example, an email might be sent to an administrator in the event that all clients 102-108 are “offline.” The client management module 212 also allows the user 120 to view license statuses and enter new licenses as well. In the event that there are insufficient licenses for the number of clients, the client management module 212 allows a user 120 to specify which clients 102-108 to track.

The report module 216 is configured to generate reports describing the usage of each client 102-108, user, and lab 110-114. The report module 216 generates real-time reports as well as usage history summaries and user login histories. The reports may be presented to the user in table or graph format and can be generated for public view or for administration only. In one embodiment, the reports may be accessible on a web server 116 such that a student could check for client 102-108 availability before traveling to the physical location of a lab 102-108. The report module may generate reports that give an overview of all labs 110- 114; the usage of a single lab over a day, week, month, or year; the total usage of all the labs over a day, week, month, or year; a side-by-side display of all single lab usages over a day, week, month, or year; and a custom report over a user-specified length of time and involving an aggregation of a user-specified number labs 110-114. The usage reports may show the number of computers in a lab 110-114, the number in use, the number available, and the number offline. Furthermore, reports may be generated for a specific user. For example, user login data may be queried to determine which user was using a client 102-108 at a given time. In another example, a list of all known users may be generated by the report module 216 for a given client 102-108, lab 110-114, or corresponding time period.

An administrator may also have access to reports depicting unassigned clients 102-108; all assigned clients 102-108 and which lab they belong to; the number of active/inactive clients 102-108; the clients 102-108 grouped by status; the number ofminutes since last check in of each client 102-108 sorted by age; and a listing of all labs 110-114 and how many clients 102-108 of each status are in each lab. Other reports may also be generated according to user preference.

The mapping module 218 is configured to create graphical maps of the labs 110-114 representing the actual physical layout of the clients 102-108 within the labs 110-114. Each client 102-108 may be represented by an icon which shows information about the client 102-108, such as the operating system, login status, current user, andpossiblyatrouble ticket. The mapping module 218 provides a graphical interface that allows a map to be edited at any time by dragging and dropping icons representing corresponding clients 102-108. In one embodiment, the graphical representations of the clients 102-108 may be color coded to show the status of the depicted clients 102-108. For example, a blue icon may mean the corresponding client 102-108 is “in use”, a grey icon may signify that a client 102-108 is “available”, and a red icon may signify that a client 102-108 is “offline.” Furthermore, a yellow warning sign may notify an administrator of a trouble ticket that has not yet been resolved. The mapping module 218 also allows a user 120 to add and remove descriptive trouble tickets on a graphical representation of a client 102-108. A trouble ticket indicates that the client 102-108 may not be functioning properly and may need attention from an administrator. Additional icons may indicate the operating system running on each individual client 102-108. For example an apple icon may be shown above a corresponding client's icon that is running a Macintosh operating system.

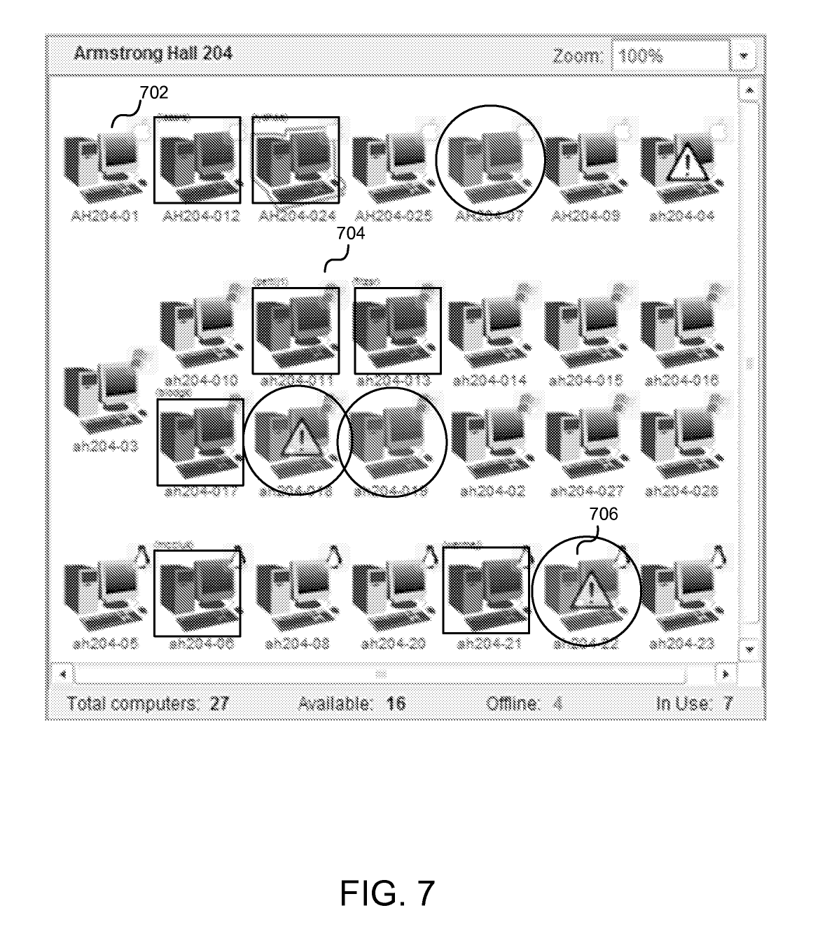

In a university setting, students or lab assistants may view a lab map generated by the mapping module 218 and immediately recognize whether a client 102-108 is currently available for use in a specific lab 110-114. Furthermore, students can immediately recognize which operating system an available client 102-108 is running. In one embodiment, the lab map is accessible on the web server 116 such that students could check lab availability from a remote location via a web browser. (see FIG. 7 for examples).

FIG. 3 is a schematic block diagram illustrating one embodiment of a database 118 in accordance with the present invention. The database 118 is used to store usage data received from the clients 102-108 as well as configuration data for the server agents 130 and client agents 122-128. In one embodiment, the database 118 includes a lab table 304, a lab definition table 306, a snapshot table 308, a computer table 310, and a configuration table 312.

The lab table 304 is used to record lab identification information and may include but is not limited to a lab identifier, a lab name, a creation date, and an active/inactive field. When a lab is no longer in use, it is marked as inactive. The lab definition table 306 may include but is not limited to an identifier, a lab identifier, a computer identifier, an IP address, and a netmask. The lab definition table 306 is used to store lab definitions. Labs 110-114 may be associated with a number of lab definitions, each of which can specify a specific computer or a group of computers. For example, a lab definition may specify a range of IP addresses. If a client 102-108 has an IP address within that range, the client 102-108 is assigned to the lab instance defined by that lab definition.

The snapshot table 308 may include but is not limited to an identifier, a lab identifier, the date and time a snapshot is taken, the total number of computers, the number of computers in use, and the number of computers offline. A snapshot of each lab 110-114 is taken by the monitor module 214 at regular intervals as specified by the user 120. Snapshot data is stored in the snapshot table 308 and is used by the report module 216 to generate reports and graphs.

The computer table 310 may include but is not limited to an identifier, a lab identifier, a client agent version, a name, an IP address, a MAC address, an operating system, the time of the last check in, the number of users, and an active/inactive field. The computer table is used to store data corresponding to each individual client 102-108. The first time a client 102-108 connects to the server agent 130, a record in the computer table is created. Each time a client checks in with the server 116, the client's entry is updated to reflect its current status. In one embodiment, the number of active clients 102-108 in the database is not allowed to exceed the number of licenses.

The configuration table 312 may include but is not limited to an identifier, an update interval, a field for the number of check in misses before inactive, a snapshot interval, a license, a customer name, a customer number, a server IP address, and the number of clients 102-108. The configuration table 312 stores global settings so that they can be preserved across a reboot of the server hosting the server agent 130. The update interval is the maximum amount of time between client check-ins. The snapshot interval is how often a snapshot of the current statistics will be placed in the snapshot table.

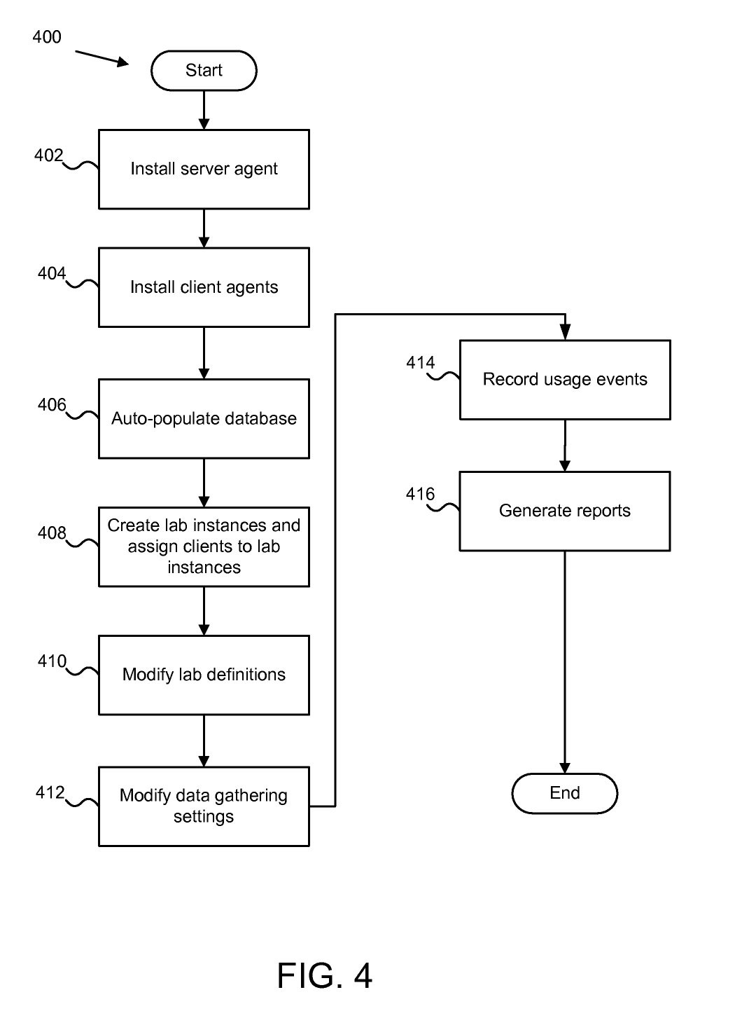

FIG. 4 is a schematic flow chart diagram illustrating one embodiment of a method 400 for monitoring the usage of one or more clients 102-108. The method 400 starts and the server agent 130 is installed 402 from the server agent module 202 onto a server 116. The server agent 130 substantially comprises the modules 202-218 described above. Next, the client agent module 204 installs 404 client agents 122-128 onto user selected clients 102-108 such that the client agent 122-128 automatically transmits client usage data to the population module 206 at regular user-defined intervals.

Once the client agents 122-128 are installed, the population module 206 auto-populates the database 118 with client usage data received from the client agents 122-128. A user 120 utilizes the lab creation module 208 to create 408 lab instances corresponding to the labs 110-114. The clients 102-108 are then assigned 408 to the lab instances according to lab definitions. The lab definitions may be modified 410 by the user 120 via the lab management module 210. The client management module 212 may be used to modify 412 the data gathering settings of the client agents 122-128 and monitor module 214. This includes changing the time intervals at which data is collected from the clients 102-108 as well as changing the time intervals at which snapshots of an entire lab 110-114 are recorded. Next, the population module 206 records 414 usage events corresponding to each client 102-108, user, and lab 110-114. The usage events may include logins and logoffs as well as user specific information. Finally, the report module 216 generates 416 reports describing the usage of each client 102-108, user, and lab 110-114. The method 400 ends.

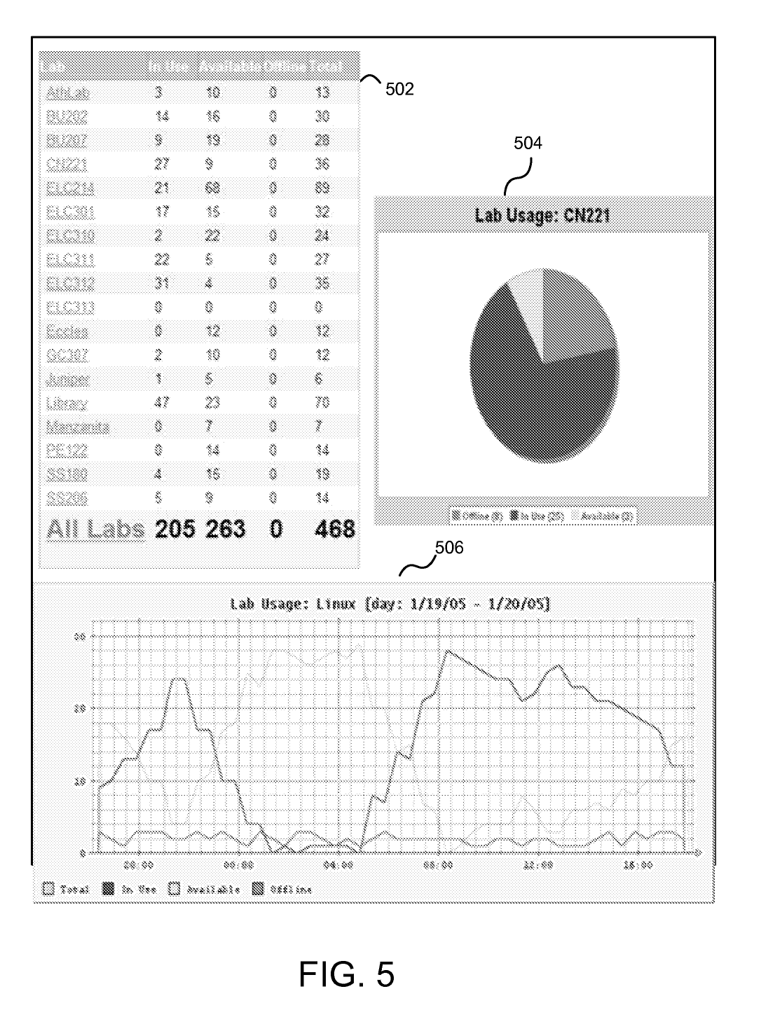

FIG. 5 is a schematic block diagram illustrating one embodiment of client usage reports generated by the report module 216. The table 502 represents data from several different labs 110-114 organized by lab name such that the total number of clients 102-108 within each lab 110- 114 is displayed as well as the number of available clients 102-108, the number of clients 102-108 in use, and the number of offline clients 102-108. Furthermore, the table 502 depicts totals for each category from all the labs 110-114 combined. Pie chart 504 demonstrates the graphical depiction of the number of clients 102-108 in Lab CN221 and the distribution of statuses from the table 502 including the number of clients 102-108 in use, the number of clients 102-108 available, and the number of clients 102-108 offline. Line graph 506 is a graphical representation of the usage of clients 102-108 within a lab during the course of a day. This allows the user 120 to determine what time of day lab use is the highest and what time of day lab use is the lowest.

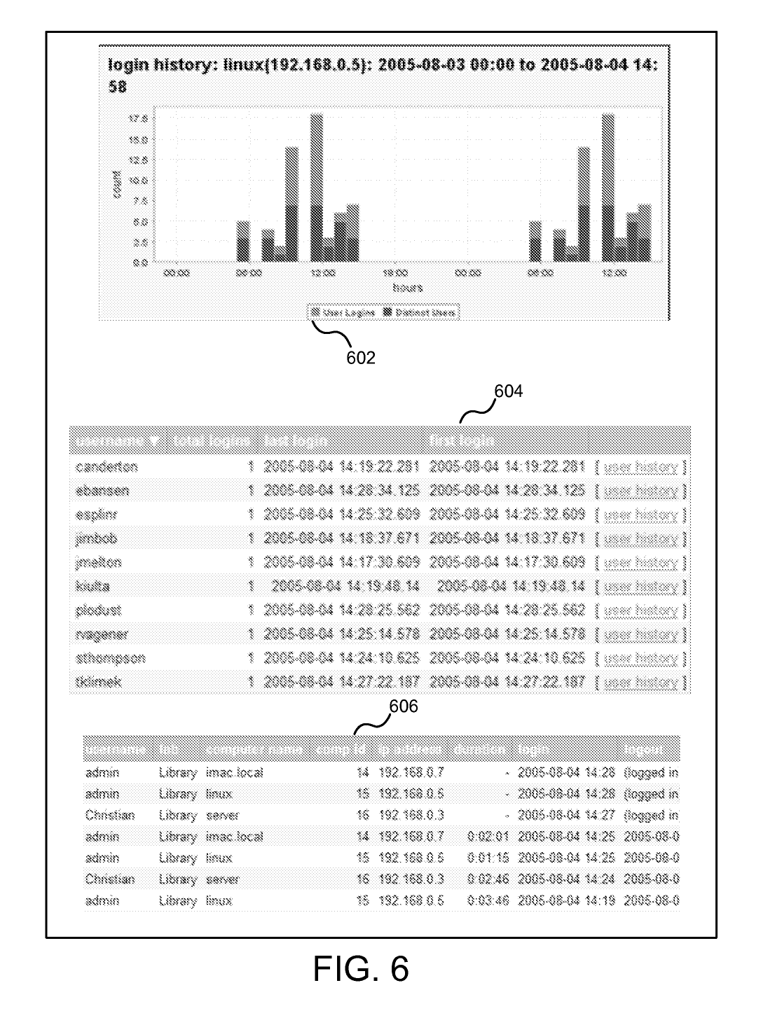

FIG. 6 is a schematic block diagram illustrating one embodiment of user usage reports generated by the report module 216. Bar graph 602 is a graphical representation of the number of logins that occurred at a specific time during the course of a day. The bar graph 602 includes a comparison of the number of total logins with the number of unique user logins. The data demonstrates that the same users are logging in multiple times during the course of a day. Table 604 depicts a login history report that includes a username, the time of last login, and the time of the user's first login. The table 604, in one embodiment, includes a link to each user's login history. The table 606 depicts a real time report of usemames, lab names, computer names, computer ID's, IP addresses, login duration, login time, and logout time.

FIG. 7 is a schematic block diagram illustrating one embodiment of a lab map graphical interface generated by the mapping module 218 in accordance with the present invention. In one embodiment, each client icon 702-704 is associated with a geometric shape to signify that the client 102-108 is in use, available, or offline. In FIG. 7 a computer icon encompassed by a circle represents an offline client, a computer icon encompassed by a square represents a client in use by another user, and a computer icon unassociated with a surrounding shape is an available client. As described above, in another embodiment, the status of a computer may be represented by a color as opposed to a geometric shape. In addition, each client icon has a smaller icon associated with it to indicate the operating system on the particular client. For example, client icon 702 includes a small apple icon above it to signify that it is running a Macintosh operating system.

The client icon locations 702-706 correspond to the actual physical location of the clients 102-108 in the lab named “Armstrong Hall 204.” The display also includes text at the bottom of the window indicating the total number of computers in the lab, the number of available computers, the number of computers in use, and the number of offline computers. The client icon 704 represents a client 101-108 that is in use and is running the Windows operating system. The client icon 706 depicts a client 102-108 that is offline and has an unresolved trouble ticket as indicated by the triangle symbol with an exclamation point. At any given moment, a user can look at the lab map and quickly discern whether there are any available clients 102-108. A lab administrator can look at the lab map and quickly discern the number of offline clients 102-108 and the number of unresolved trouble tickets.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for monitoring the usage of one or more clients or groups of clients, the method comprising:
creating lab definitions and assigning clients to a lab instance;
monitoring a client for a change in status at regular intervals and sending client usage data to a server if there is a change in status; and

2. The method of claim 1, further comprising sending client usage data to the server at a regular update interval regardless of whether a status change on a client occurs.

3. The method of claim 1, further comprising auto-populating a database with client usage data.

4. The method of claim 1, further comprising organizing client usage data in the database such that each client has a unique client record in a database.

5. The method of claim 1, further comprising querying the status of each client record at regular intervals and storing the result in a separate record in a database.

6. The method of claim 1, further comprising generating lab usage reports, client usage reports, and user usage reports.

7. The method of claim 1, further comprising generating a dynamic map report which autonomically updates the reported status of a client on the map from a client record stored in the database

8. The method of claim 1, further comprising logging a user off of a client and changing a client's status to offline if a client fails to send an update for a specified number of update intervals.

9. The method of claim 1, further comprising autonomically sending a notification to a specified user if a client is offline for a given time interval or if the client is online but has not been logged into for a given time interval.

10. An apparatus to monitor the usage of one or more clients or groups of clients, the apparatus comprising:
a client agent module configured to monitor a client for a change in status at regular intervals and send client usage data to the server if there is a change in status, and to transmit client usage data to the server at regular user-defined intervals;
a lab creation module configured to create lab definitions and assign one or more clients to a lab instance according to a lab definition;
a population module configured to receive messages from one or more client agent modules and auto-populate a database with client usage data provided by one or more client agents such that each client has a unique client record in a database;
a monitor module configured to query the status of each client record at regular intervals and store the result in a separate record in a database;
a lab management module configured to allow a user to modify a lab definition and add and remove one or more clients from a lab instance;
a client management module configured to modify data gathering settings on a client agent, to log a user off of a client and change a client's status to offline if a client fails to send an update for a specified number of update intervals, and to send a notification to a specified user if a client is offline for a given time interval or if the client is online but has not been logged into for a given time interval;
a report module configured to generate reports of client, user, and lab events; and
a mapping module configured to create graphical maps of clients assigned to a lab instance, provide client status and lab information for a given client or lab, and update client status and lab information in response to changes in status.

11. The Apparatus of claim 10, wherein the client usage data comprises user login status, time, client IP address, and client MAC address.

12. The apparatus of claim 10, wherein the report module is further configured to send a notification to a defined user in response to the occurrence of a predefined event.

13. The apparatus of claim 10, wherein the mapping module is further configured to allow a user to remove or add clients to a lab map.

14. The apparatus of claim 10, wherein the mapping module is further configured to allow a user to add or remove a descriptive ticket assigned to a client for display on a graphical map.

15. A system for monitoring the usage of one or more clients or groups of clients, the system comprising:
one or more clients;
one or more labs, each comprising one or more clients;
a server in electronic communication with one or more clients;
a database in electronic communication with the server;
a lab creation module configured to create a lab instance and assign one or more clients to a lab instance according to a lab definition;
a client agent module configured to monitor a client for a change in status at regular intervals and send client usage data to the server if there is a change in status, and to autonomically transmit client usage data to the server at regular intervals; and
a server agent module configured to receive messages from a client agent module and to query the status of each client record at regular intervals and store the result in a separate record in a database.

16. The system of claim 15, wherein the server agent module further comprises a population module configured to receive messages from one or more client agent modules and auto-populate a database with client usage data provided by one or more client agents such that each client has a unique client record in a database;

17. The system of claim 15, wherein the server agent module further comprises a monitor module configured to query the status of each client record at regular intervals and store the result in a separate record in a database.

18. The system of claim 15, wherein the server agent module further comprises a lab management module configured to allow a user to modify a lab definition and add and remove one or more clients from a lab instance.

19. The system of claim 15, wherein the server agent module further comprises a client management module configured to modify data gathering settings on a client agent, to log a user off of a client and changing a client's status to offline if a client fails to send an update for a specified number of update intervals, and to send a notification to a specified user if a client is offline for a given time interval or if the client is online but has not been logged into for a given time interval.

20. The system of claim 15, wherein the server agent module further comprises a report module configured to generate reports of client, user, and lab events.

21. The system of claim 15, wherein the server agent module further comprises a mapping module configured to create graphical maps of clients assigned to a lab instance, provide client status and lab information for a given client or lab, and update client status and lab information in response to changes in status.
